(19) United States
(12) Patent Application Publication
(10) Pub. No.: US 2017/0052434 A1
(43) Pub. Date: Feb. 23, 2017

(54) STRUCTURE FOR COOLING AN ILLUMINATION OPTICAL SYSTEM AND PROJECTION DISPLAY APPARATUS

(71) Applicant: NEC DISPLAY SOLUTION, LTD., Tokyo (JP)

(72) Inventor: Naoki MASUDA, Tokyo (JP)

(21) Appl. No.: 15/304,005

(22) PCT Filed: Apr. 30, 2014
(86) PCT No.: PCT/JP2014/061955

§ 371 Date: Oct. 13, 2016

(51) Int. Cl. G03B 21/16; F21V 29/67; G03B 21/20; F21V 9/16; F21V 5/04; F21V 29/83; F21V 29/502; G02B 26/00

(52) U.S. Cl. CPC G03B 21/16; F21V 29/502; F21V 29/673; G02B 26/008; F21V 9/16; F21V 5/04; F21V 29/83; F21V 29/677; G03B 21/204

(57) ABSTRACT

A cooling structure for an illumination optical system includes: a fluorescent unit having a fluorescent layer that emits fluorescent light due to excitation light radiated from a light source; a fan for blowing cooling air to the fluorescent unit; and a duct that partitions an internal space and an external space, the internal space having the fluorescent unit disposed therein, and that guides the cooling air blown from the fan to the fluorescent unit.

### TECHNICAL FIELD

The present invention relates to a cooling structure of an illumination optical system that uses fluorescent material and to a projection display apparatus.

### BACKGROUND ART

In recent years, illumination optical systems have been proposed that are equipped with fluorescent material that emits fluorescent light in response to the irradiation of excitation light. This type of illumination optical system is used in, for example, a projection display apparatus. FIG. 1 shows a perspective view of a projection display apparatus that is provided with an illumination optical system that is related to the present invention. FIG. 2 shows a perspective view of an illumination optical system that is related to the present invention, and FIG. 3 shows a plan view of an illumination optical system that is related to the present invention.

As shown in FIG. 1, projection display apparatus 101 that is related to the present invention is provided with illumination optical system 103 and image generation optical system into which light from illumination optical system 103 is irradiated. As shown in FIG. 2 and FIG. 3, illumination optical system 103 is provided with laser light source 107 and fluorescent wheel 112 that is provided with a fluorescent layer that is irradiated by laser light emitted from laser light source 107.

The system disclosed in Patent Document 1 is one example of an illumination optical system that is provided with this type of fluorescent wheel. In Patent Document 1, an illumination optical system is disclosed that is provided with a fluorescent unit that has a fluorescent wheel and a motor that rotates the fluorescent wheel.

The fluorescent wheel disclosed in Patent Document 1 has a substrate that is provided to freely rotate around a rotational axis that is orthogonal to one surface. A fluorescent region and a reflective region are formed on one surface of the substrate. The fluorescent region has a fluorescent layer that produces fluorescent light of a predetermined wavelength in response to irradiation of laser light. The reflective region is a region that reflects laser light. The laser light that is irradiated upon the fluorescent wheel is repeatedly irradiated upon the fluorescent region and the reflective region of the rotating fluorescent wheel, whereby the fluorescent light that is emitted from the fluorescent material and the laser light that is reflected by the reflective region are successively emitted from the fluorescent wheel.

The illuminance of the light that is emitted from this illumination optical system depends on the quantity of fluorescent light that is generated from the fluorescent material. The fluorescent material produces heat as it undergoes laser light irradiation and has a property by which the light-emission efficiency is decreased by the production of heat. Accordingly, heat that is generated from the fluorescent material must be controlled to prevent any decrease of the illuminance of light produced from the illumination optical system.

A construction is disclosed in Patent Document 2 that has a fluorescent wheel on which depressions are formed in the fluorescent layer and a fan that blows cooling air toward the depressions of the fluorescent wheel. In the construction disclosed in Patent Document 2, turbulence is produced by blowing the cooling air upon the depressions of the fluorescent wheel and an improvement in the cooling efficiency of the fluorescent material is due to the effect of heat diffusion.

### LITERATURE OF THE PRIOR ART

### Patent Documents

### Patent Document 1: WO 2012/127554

### Patent Document 2: Japanese Unexamined Patent Application Publication No. 2012-078707

### Patent Document 3: Japanese Unexamined Patent Application Publication No. 2013-025249

### SUMMARY OF THE INVENTION

### Problem to be Solved by the Invention

In the illumination optical system described in Patent Document 1 described above, the fluorescent material is cooled by the flow of air surrounding the fluorescent wheel that the fluorescent wheel itself receives when the fluorescent wheel is rotating. As a result, the cooling effect of cooling the fluorescent material is rather poor in the illumination optical system described in Patent Document 1.

In the construction disclosed in Patent Document 2, cooling air is blown locally toward the laser light irradiation portion of the fluorescent layer of the fluorescent wheel. In this construction described in Patent Document 2, the effect of cooling the fluorescent material is still inadequate, and a further increase of the cooling efficiency is to be desired.

In Patent Document 3, a construction is disclosed in which a fan is arranged in the vicinity of the fluorescent wheel that causes cooling air to flow toward the surface on the side on which the fluorescent layer is formed. However, in an illumination optical system that uses a fluorescent wheel, a condensing lens for condensing the fluorescent light that is emitted from the fluorescent layer is arranged adjacent to the fluorescent layer. As a result, the cooling air blows against the lens holder that supports the condensing lens and thus obstructs the flow of cooling air, whereby the flow of a sufficient amount of cooling air on the surface of the fluorescent wheel becomes problematic. The problem arises in the construction described in Patent Document 3 that in which cooling air is thus guided only to one side of the surface of the fluorescent wheel and the flow of the cooling air is obstructed by the lens holder, and the cooling efficiency of the fluorescent material is therefore low.

In addition, as shown in FIGS. 2 and 3, the illumination optical system that uses a laser light source is typically covered by cover 110 so that laser light does not leak to the outside of illumination optical system 103 other than from lens 111 that emits light from illumination optical system 103. Accordingly, illumination optical system 103 is of a construction that is closed off from the outside. As a result, in illumination optical system 103 that uses laser light source 107, the interior of cover 110 is prone to increase in the ambient temperature, and the air inside cover 110 tends to become hot due to the heat produced in laser light source 107. As a result, the surrounding air that is received by fluorescent wheel 112 itself that is arranged inside cover 110 is also in a hot state, and the problem therefore arises that the cooling efficiency of the fluorescent material is low.

Accordingly, the low cooling efficiency of the fluorescent material in the illumination optical system described above that is related to the present invention results in a tendency for the temperature of the fluorescent material to increase, with the result that the illuminance of light emitted from the illumination optical system decreases. The problem consequently arises in which maintaining decreases in line with increases in the continued use of the illumination optical system.

It is therefore an object of the present invention to provide a structure for cooling an illumination optical system and a projection display apparatus that allow an increase in the cooling efficiency of the fluorescent material and thus prevent a decrease in the illuminance of light emitted from the illumination optical system.

### Means for Solving the Problem

To achieve the above-described object, the structure for cooling an illumination optical system according to the present invention is provided with a fluorescent unit having a fluorescent layer that emits fluorescent light in response to excitation light that is irradiated from a light source, a fan that supplies cooling air to the fluorescent unit, and a duct that partitions the internal space and the external space in which the fluorescent units is arranged and that guides cooling air supplied from the fan to the fluorescent unit.

In addition, the projection display apparatus according to the present invention is provided with an illumination optical system that includes the above-described cooling structure for an illumination optical system and an image generation optical system that includes an image element that modulates light emitted from the illumination optical system in conjunction with an image signal.

### Effect of the Invention

The present invention enables an increase in the efficiency of cooling a fluorescent material and can thus prevent a decrease in the illuminance of light that is emitted from an illumination optical system.

### BRIEF DESCRIPTION OF THE DRAWINGS

FIG. 1 is a perspective view showing a projection display apparatus that is equipped with an illumination optical system related to the present invention.

FIG. 2 is a perspective view showing an illumination optical system that is related to the present invention.

FIG. 3 is a plan view showing an illumination optical system related to the present invention.

FIG. 4 is a perspective view that shows a see-through view of the projection display apparatus of the first exemplary embodiment.

FIG. 5 is a perspective view that shows the illumination optical system that is provided in the projection display apparatus of the first exemplary embodiment.

FIG. 6 is a perspective view for describing the cooling structure of the illumination optical system of the first exemplary embodiment.

FIG. 7 is a plan view showing the cooling structure of the illumination optical system of the first exemplary embodiment.

FIG. 8 is a plan view that shows an enlarged view of the cooling structure of the illumination optical system of the first exemplary embodiment.

FIG. 9 is a perspective view that shows an enlarged view of the duct and lens holder belonging to the cooling structure of the illumination optical system of the first exemplary embodiment.

FIG. 10 is a perspective view for describing the cooling structure of the illumination optical system of the second exemplary embodiment.

FIG. 11 is a plan view showing the cooling structure of the illumination optical system of the second exemplary embodiment.

FIG. 12 is a plan view that shows an enlargement of the cooling structure of the illumination optical system of the second exemplary embodiment.

FIG. 13 is a perspective view that shows the duct and lens holder belonging to the cooling structure of the illumination optical system of the second exemplary embodiment.

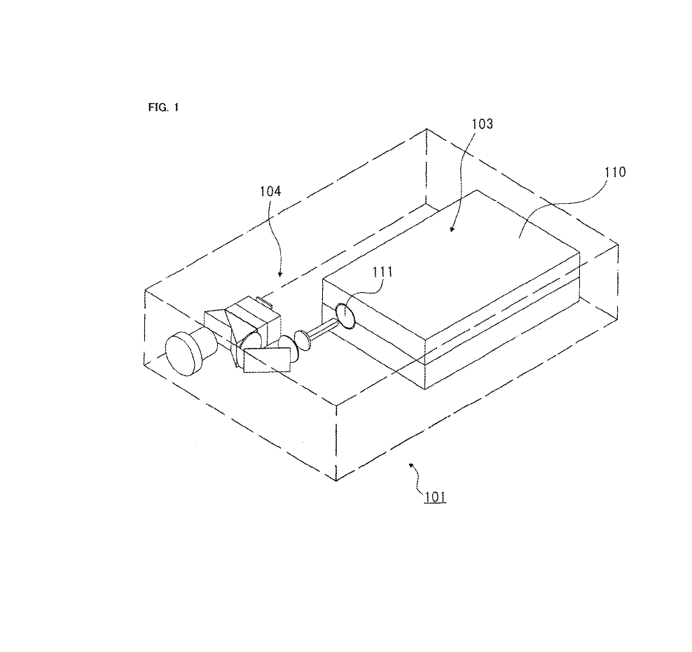

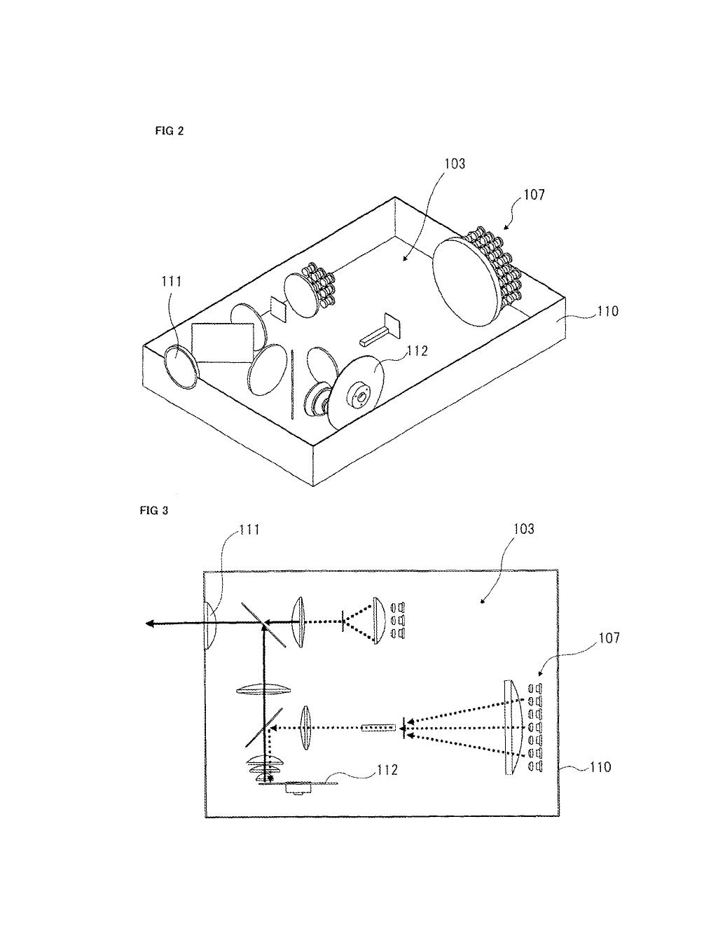

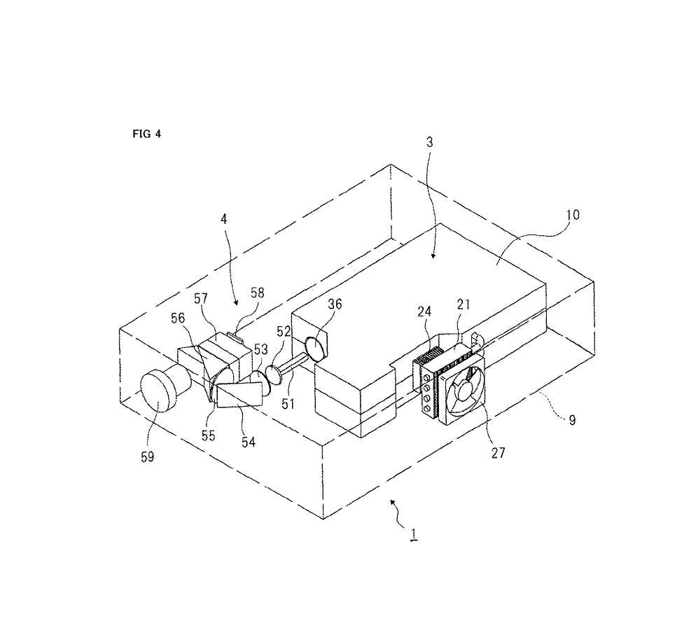

### BEST MODE FOR CARRYING OUT THE INVENTION

Actual exemplary embodiments of the present invention are next described with reference to the accompanying drawings.

### First Exemplary Embodiment

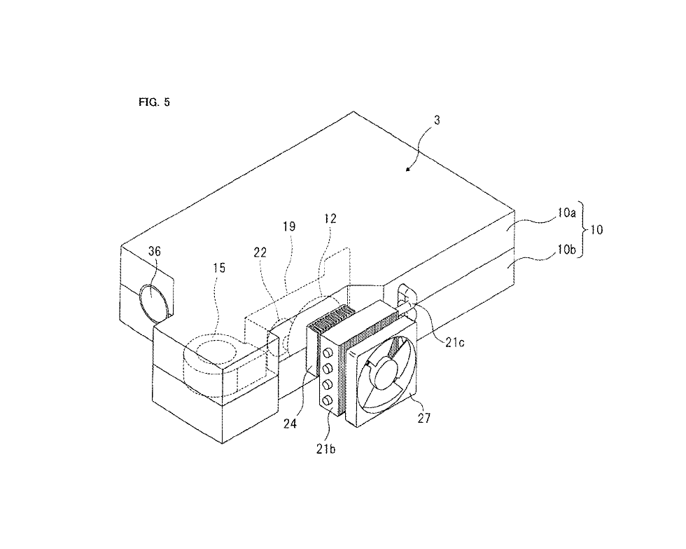

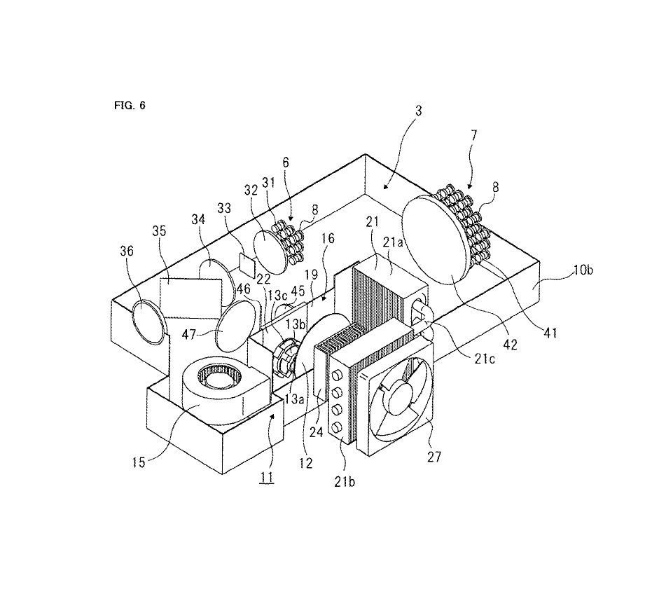

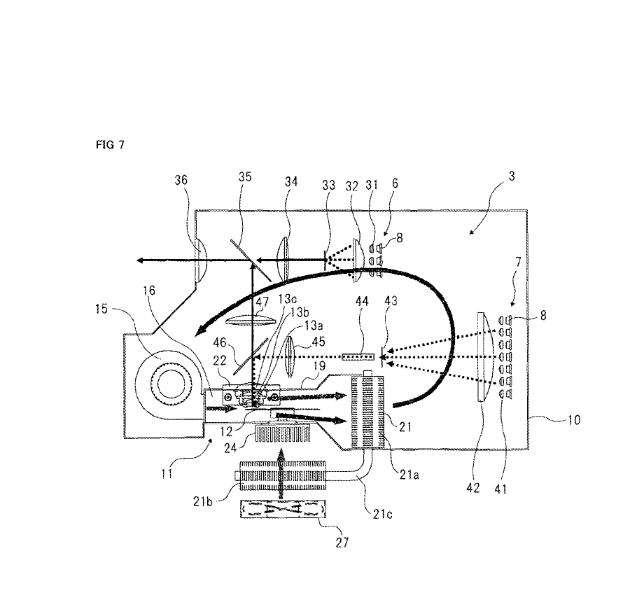

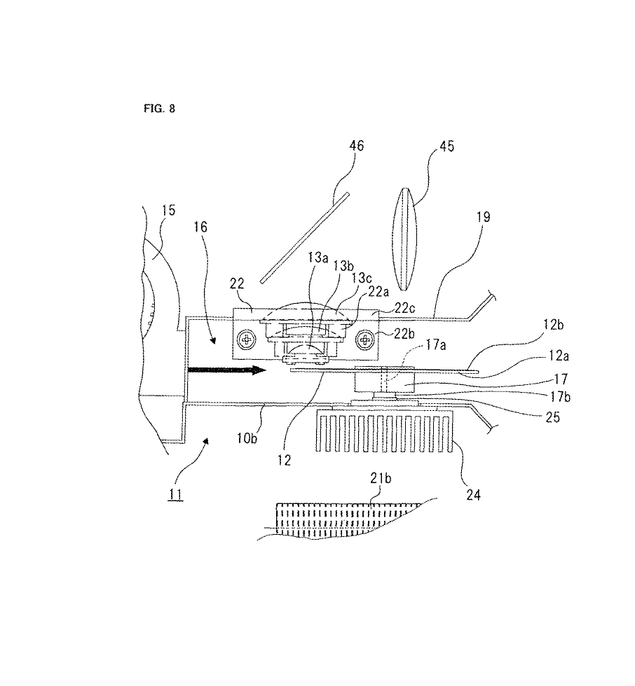

FIG. 4 shows a see-through perspective view of the projection display apparatus of the first exemplary embodiment. FIG. 5 shows a perspective view of the illumination optical system that is provided in the projection display apparatus of the first exemplary embodiment. FIG. 6 shows a perspective view for describing the cooling structure of the illumination optical system of the first exemplary embodiment. FIG. 7 shows a plan view of the cooling structure of the illumination optical system of the first exemplary embodiment.

As shown in FIGS. 4 and 5, projection display apparatus 1 of the first exemplary embodiment is provided with illumination optical system 3 that uses fluorescent material, and image generation optical system 4 into which light from illumination optical system 3 is irradiated and that generates an image that is projected upon a projection surface.

As shown in FIGS. 6 and 7, illumination optical system 3 is provided with first laser light source 6 and second laser light source 7 that emit laser light, a first optical component group that makes up a first optical path of laser light that is emitted from first laser light source 6, and a second optical component group that makes up a second optical path of laser light that is emitted from the second laser light source 7. In addition, illumination optical system 3 is provided with cover 10 that both covers the entirety of the first optical path and covers the entirety of the second optical path that includes the optical path from second laser light source 7 to fluorescent wheel 12.

As shown in FIG. 6, first and second laser light sources 6 and 7 have a plurality of laser diodes 8 that emit blue laser light having a blue wavelength, the plurality of laser diodes 8 being arranged in an array on a flat surface. First and second laser light sources 6 and 7 are not limited to components that emit blue laser light. Components that emit light of other wavelengths such as ultraviolet light may also be used as first and second laser light sources 6 and 7. The first and second optical component groups will be described later. Cover 10 is realized by combining a set of upper cover 10a and lower cover 10b.

As shown in FIG. 6, the second optical path includes fluorescent wheel 12 that emits fluorescent light in response to irradiation of laser light that is emitted from second laser light source 7, and a plurality of condensing lenses 13a, 13b, and 13c for condensing fluorescent light that is emitted from fluorescent wheel 12. Illumination optical system 3 is then provided with cooling structure 11 for cooling fluorescent wheel 12.

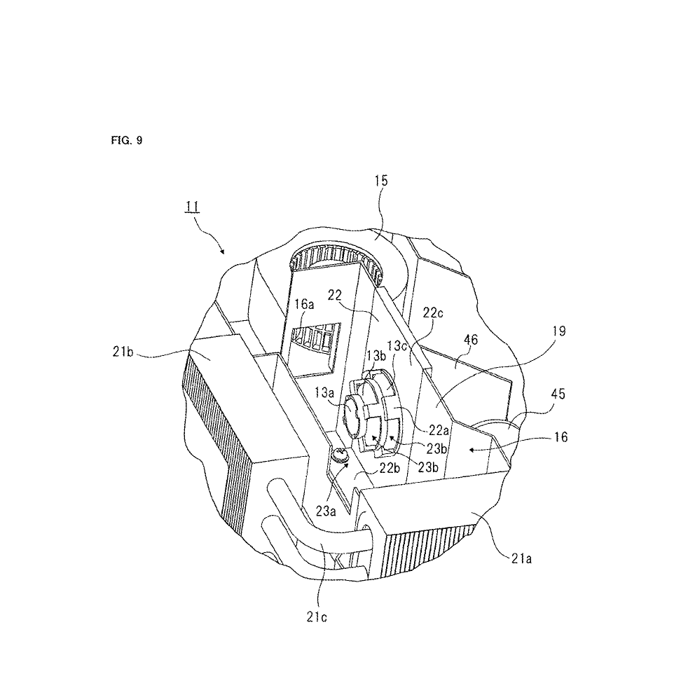

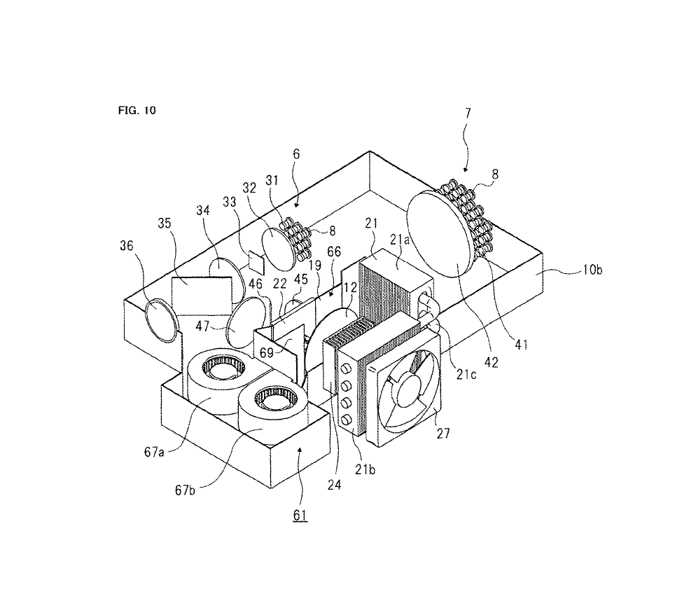

FIG. 8 shows an enlarged plan view of cooling structure 11 of the illumination optical system of the first exemplary embodiment. FIG. 9 shows an enlarged perspective view of the duct and lens holder that belong to cooling structure 11 of the illumination optical system of the first exemplary embodiment.

As shown in FIGS. 7 and 8, cooling structure 11 of the illumination optical system of the first exemplary embodiment includes: fluorescent wheel 12 as the fluorescent unit that has fluorescent layer 12b that emits fluorescent light in response to laser light as the excitation light that is irradiated from second laser light source 7, fan 15 that supplies cooling air to fluorescent wheel 12, and duct 16 that partitions the external space and internal space in which fluorescent wheel 12 is arranged and that guides cooling air supplied from fan 15 to fluorescent wheel 12.

As shown in FIG. 8, fluorescent wheel 12 is made up of substrate 12a on which fluorescent layer 12b is formed. Substrate 12a is attached to rotational axis 17a of wheel motor 17 and enables to allow rotation around rotational axis 17a that is parallel to a direction that is orthogonal to the principal plane of substrate 12a. Wheel motor 17 is attached to the bottom panel of lower cover 10b. Fluorescent layer 12b is formed by applying fluorescent material to disk-shaped substrate 12a. The fluorescent material emits yellow fluorescent light having a wavelength band that extends from a green wavelength to a red wavelength.

Fluorescent wheel 12 of the present exemplary embodiment is configured to emit only yellow light, but fluorescent wheel 12 is not limited to this form. As fluorescent wheel 12, a fluorescent layer may be partitioned to emit fluorescent light of a different color according to the irradiation position of the laser light on the fluorescent layer.

Through the use of fluorescent wheel 12, the irradiation position of laser light changes with the rotation of fluorescent wheel 12, whereby any imbalance in the temperature of the fluorescent material in each portion of fluorescent layer 12b can be controlled. As a result, a decrease of the efficiency of conversion to fluorescent light in a portion of fluorescent layer 12b can be prevented and the fluorescent light can be stabilized and easily obtained.

Fan 15 is arranged inside cover 10. A sirocco fan is used as fan 15, and fan 15 has an air supply port that supplies cooling air.

As shown in FIGS. 6 and 7, duct 16 is arranged inside cover 10, and further, has partition wall 19 that extends so as to supply the cooling air that is supplied from fan 15 in a direction that is orthogonal to rotational axis 17a of wheel motor 17. Partition wall 19 is formed on the bottom panel of lower cover 10b and along a side panel of lower cover 10b. Duct 16 is provided inside cover 10 and is formed by partition wall 19, the upper panel of upper cover 10a, and the bottom and side panels of lower cover 10b. In this way, duct 16 has an internal space that is closed off by partition wall 19, by the upper panel of upper cover 10a, and by the bottom and side panels of lower cover 10b, the internal space being formed as a channel for cooling air that is supplied from fan 15.

As shown in FIG. 9, port 16a that is linked to the air supply port of fan 15 is provided at one end of duct 16. In addition, as shown in FIG. 7, heat exchanger 21 is provided as a cooling component for cooling the cooling air at the other end of duct 16 that is the downstream side with respect to fluorescent wheel 12. Cooling air that has passed by way of fluorescent wheel 12 is cooled by heat exchanger 21. In addition, as shown in FIG. 7, the cross-section area of the channel is enlarged at the other end of duct 16. By enlarging the cross-section area of the channel at the other end of duct 16, the amount of cooling air that is blown against heat exchanger 21 is increased.

As shown in FIGS. 6 and 7, heat exchanger 21 includes heat-receiving part 21a that is arranged inside the other end of duct 16, cooling unit 21b that is arranged outside duct 16, and heat-transfer part 21c that transfer heat from heat-receiving part 21a to cooling unit 21b. Heat exchanger 21 takes the heat from the air that was heated by cooling fluorescent wheel 12, thus cooling the air. Arranging heat exchanger 21 in duct 16 in this way allows the circulation of cooling air that has been cooled by heat exchanger 21 to fan 15 and raises the cooling efficiency of the fluorescent material that uses cooling air that is supplied from fan 15. In addition, a liquid-cooled cooling mechanism that circulates a liquid for cooling may also be used as a heat exchanger.

As shown in FIG. 8, fluorescent wheel 12 and wheel motor 17 are arranged inside duct 16. In addition, a plurality of condensing lenses 13a, 13b, and 13c and lens holder 22 that holds the plurality of condensing lenses 13a, 13b, and 13c are provided inside duct 16 adjacent to the surface of fluorescent wheel 12 on which fluorescent layer 12b is formed.

As shown in FIGS. 8 and 9, lens holder 22 has support unit 22a that supports the outer peripheries of each of condensing lenses 13a, 13b, and 13c and base 22b that supports support unit 22a.

Base 22b of lens holder 22 is formed in plate form that has an L-shaped cross section and is fixed to the bottom panel of lower cover 10b. Base 22b has upright wall 22c. Support unit 22a is provided at a position separated from the bottom panel of lower cover 10b of upright wall 22c. In addition, upright wall 22c is linked together with partition wall 19 of duct 16 and is formed as a part of partition wall 19.

Forming lens holder 22 as described hereinabove secures first air passage 23a through which cooling air flows between support unit 22a and the bottom panel of lower cover 10b and improves the ventilation characteristics of the cooling air. The obstruction of cooling air supplied from fan 15 by lens holder 22 can thus be prevented and the cooling air is able to flow smoothly along partition wall 19 of duct 16.

Support unit 22a of lens holder 22 supports the outer periphery of each of condensing lenses 13a, 13b, and 13c. Support unit 22a includes a plurality of second air passages 23b between each of the plurality of condensing lenses 13a, 13b, and 13c through which passes the cooling air that is supplied from fan 15. Due to the inclusion of second air passages 23b, support unit 22a does not obstruct the flow of cooling air that is supplied from fan 15 and allows the efficient cooling of fluorescent layer 12b.

Further, as shown in FIGS. 7 and 8, heat sink 24 is provided outside duct 16 as a heat-discharging part for discharging the heat that was transferred from rotational axis 17a to the outside of duct 16.

Heat sink 24 is linked to axle bearing 17b of rotational axis 17a that belongs to wheel motor 17. As shown in FIG. 8, heat transfer sheet 25 is interposed between axle bearing 17b and heat sink 24, and heat is conveyed from axle bearing 17b to heat sink 24 by way of heat transfer sheet 25 and discharged from heat sink 24. The use of heat sink 24 thus raises the effect of cooling the fluorescent material of fluorescent wheel 12. As a modification, instead of a configuration in which heat transfer sheet 25 contacts axle bearing 17b, heat transfer sheet 25 may also be configured to directly contact rotational axis 17a.

In addition, as shown in FIGS. 6 and 7, another fan 27 is provided outside cover 10 that is outside duct 16 that supplies cooling air to heat sink 24 and cooling unit 21b of heat exchanger 21. Heat sink 24 and cooling unit 21c are arranged at positions outside duct 16 such that heat sink 24 faces cooling unit 21c.

A propeller fan is used as fan 27. As shown in FIG. 4, projection display apparatus 1 of the present exemplary embodiment is provided with case 9 with illumination optical system 3 provided inside, and fan 27 is arranged at a position that faces cooling unit 21b inside case 9.

The cooling air that is supplied from fan 27, after having cooled cooling unit 21b, passes by way of cooling unit 21b and is blown against heat sink 24. In this way, cooling unit 21b and heat sink 24 can be efficiently cooled by using the cooling air that is supplied from one fan 27, and cooling structure 11 is thus simplified.

Although a construction was adopted in the present exemplary embodiment in which cooling air that has passed through cooling unit 21b of heat exchanger 21 is blown against heat sink 24, the present exemplary embodiment is not limited to this form. As a modification, a configuration may of course be adopted in which cooling air that has passed through heat sink 24 is blown against cooling unit 21b, or in which cooling air is caused to flow between heat sink 24 and cooling unit 21b.

In the first optical path of illumination optical system 3, laser light that is emitted from laser diode 8 of first laser light source 6 is condensed by condensing lens 31, as shown in FIGS. 6 and 7. The light that has been condensed by condensing lens 31 is condensed toward diffuser 33 by condensing lens 32. The laser light that is irradiated upon diffuser 33 is diffused and then irradiated into condensing lens 34. The light that is irradiated into condensing lens 34 is irradiated into dichroic mirror 35. Dichroic mirror 35 transmits light that has a blue wavelength, and further, reflects light of a wavelength that is longer than a green wavelength. Accordingly, dichroic mirror 35 transmits blue laser light that was emitted from first laser light source 6 and reflects yellow light that is emitted from fluorescent layer 12b of the above-described fluorescent wheel 12. The yellow light that is reflected by dichroic mirror 35 and the blue laser light that is transmitted through dichroic mirror 35 are irradiated into condensing lens 36 and emitted from illumination optical system 3. The light that is emitted from illumination optical system 3 is irradiated into image generation optical system 4.

On the second optical path of illumination optical system 3, the laser light that is emitted from laser diode 8 of second laser light source 7 is condensed by condensing lens 41, as shown in FIGS. 6 and 7. The light that is condensed by condensing lens 41 is condensed toward diffuser 43 by condensing lens 42. The light that is irradiated upon diffuser 43 is diffused and then irradiated into light tunnel 44. Light tunnel 44 is a hollow optical element, each of its interior upper and lower surfaces and right-side and left-side surfaces being formed as reflecting mirrors. Light that is irradiated into light tunnel 44 is repeatedly reflected by the inner surfaces of light tunnel 44, whereby the illuminance distribution of light at the emission portion of light tunnel 44 is made uniform. As a modification, a rod lens (rod integrator) may also be used in place of light tunnel 44.

Light that is emitted from light tunnel 44 is condensed by condensing lens 45. The light that has been condensed by condensing lens 45 is irradiated into dichroic mirror 46. Dichroic mirror 46 reflects light that has a blue wavelength and transmits light of wavelengths that are longer than a green wavelength. The blue laser light that is reflected by dichroic mirror 46 passes through condensing lenses 13a, 13b, and 13c and is irradiated into fluorescent layer 12b of fluorescent wheel 12. The fluorescent material is excited by the blue laser light and radiates yellow fluorescent light.

The yellow light that is radiated from the fluorescent material is condensed by condensing lenses 13a, 13b, and 13c and irradiated into dichroic mirror 46. The yellow light that is irradiated into dichroic mirror 46 is transmitted through dichroic mirror 46 and irradiated into condensing lens 47. The yellow light that is irradiated into condensing lens 47 is irradiated into dichroic mirror 35. The yellow light that is irradiated into dichroic mirror 35 is reflected by dichroic mirror 35 and irradiated into condensing lens 36.

In image generation optical system 4 that is provided in projection display apparatus 1, light that has been emitted from condensing lens 36 of illumination optical system 3 is irradiated into light tunnel 51, as shown in FIG. 4. The light that is irradiated into light tunnel 51 is repeatedly reflected inside light tunnel 51, whereby the illuminance distribution of light at the emission portion of light tunnel 51 is made uniform. The light that is emitted from light tunnel 51 becomes white light that is the synthesized light of yellow light and blue light. The white light passes through condensing lenses 52 and 53 and is reflected by mirror 54. The white light that is reflected by mirror 54 passes through condensing lens 55 and is irradiated into TIR (Total Internal Reflection) prism 56. The light that is irradiated into TIR prism 56 undergoes total reflection inside and is then irradiated into color prism 57. Color prism 57 separates the white light into green light, red light, and blue light.

The light that has been separated in color prism 57 is irradiated into DMDs (Digital Mirror Devices) that serve as image elements that modulate this light with an image signal. The green light that was separated by color prism 57 is irradiated into green light DMD 58. Similarly, the red light that was separated by color prism 57 is irradiated into red light DMD (not shown), and the blue light that was separated by color prism 57 is irradiated into blue light DMD (not shown). As a modification, a liquid crystal panel (LCD) may be used as an image element in place of the DMDs.

DMD 58 has a multiplicity of micromirrors arrayed in matrix form, each micromirror corresponding to a picture element of the image that is to be projected. The micromirrors are configured so as to allow adjustment of the angle of each micromirror. Light that is irradiated into a micromirror that has a certain angle is reflected toward projection lens 59. Accordingly, green light, red light, and blue light that are reflected at each DMD are irradiated into color prism 57 and synthesized in color prism 57. The light that is synthesized at color prism 57 passes through TIR prism 56 and projection lens 59 and is then projected upon a projection surface such as a screen.

The operation by which fluorescent wheel 12 is cooled by fan 15 and duct 16 is next described with regard to cooling structure 11 of an illumination optical system that has been configured as described hereinabove.

Cooling air that is supplied from fan 15 flows inside duct 16 along partition wall 19 and is blown against both surfaces of substrate 12a of fluorescent wheel 12. The cooling air that is blown against the surface on the side of fluorescent layer 12b of fluorescent wheel 12 passes through air passages 23 of lens holder 22 and the space on the peripheral side of support unit 22a of lens holder 22 and flows smoothly along the surface on the fluorescent layer 12b side. In this way, cooling air supplied from fan 15 is guided along duct 16 and effectively cools the entirety of fluorescent wheel 12.

Cooling air that has cooled fluorescent layer 12b of fluorescent wheel 12 further flows along partition wall 19 and is cooled by heat exchanger 21. The air that has been cooled by heat exchanger 21 is discharged from duct 16, passes through the interior of illumination optical system 3, and circulates to fan 15 as shown by the arrow in FIG. 7. Accordingly, fan 15 is capable of supplying the cooling air that has been cooled by heat exchanger 21 to fluorescent wheel 12, whereby the cooling efficiency of the fluorescent material is increased.

Cooling unit 21b of heat exchanger 21 is further cooled by the cooling air supplied from fan 27. Heat sink 24 is cooled by the cooling air that has cooled cooling unit 21b. Fluorescent layer 12b of fluorescent wheel 12 is cooled by the cooling of heat sink 24.

Compared to a configuration in which a fan is simply arranged in the vicinity of the fluorescent wheel inside the case of a projection display apparatus, the present exemplary embodiment enables cooling of air surrounding fluorescent wheel 12 by the cooling air that is guided along duct 16. In this way, the fluorescent material can be efficiently cooled.

In addition, because lens holder 22 that is arranged inside duct 16 has air passages 23, obstruction of the flow of cooling air supplied from fan 15 is prevented. The cooling efficiency of the fluorescent material is increased by the combined effect of each of these configurations for increasing the ventilation characteristics of cooling air.

As described hereinabove, cooling structure 11 of the illumination optical system of the first exemplary embodiment is provided with duct 16 that guides cooling air supplied from fan 15 to fluorescent wheel 12, whereby the temperature of air surrounding fluorescent wheel 12 is lowered by the cooling air that is guided along duct 16, enabling efficient cooling of the fluorescent material. As a result, cooling structure 11 is able to improve the cooling efficiency of the fluorescent material and prevent a decrease in the illuminance of the light that is emitted from illumination optical system 3.

In addition, lens holder 22, by incorporating spaces between support unit 22a and the bottom panel of lower cover 10b, prevents obstruction of the flow of cooling air supplied from fan 15 and enables adequate flow of the cooling air to the surface of fluorescent wheel 12 on the side of fluorescent layer 12b. Lens holder 22 further, by incorporating air passages 23, prevents obstruction of the flow of cooling air supplied from fan 15 and enables the smooth flow of cooling air to the surface of fluorescent wheel 12 on the side of fluorescent layer 12b. As a result, the effect of cooling the fluorescent material can be increased.

Finally, due to the incorporation of heat exchanger 21, cooling structure 11 is capable of both preventing an increase in the temperature of the cooling air that is supplied by fan 15, and further, efficiently cooling fluorescent wheel 12. In addition, cooling structure 11, by incorporating heat is capable of sink 24, is capable of discharging the heat of fluorescent wheel 12 to the outside of duct 16.

### Second Exemplary Embodiment

A second illumination optical system cooling structure is next described. For the sake of convenience, constituent elements in the illumination optical system that is provided with the cooling structure of the second exemplary embodiment that are identical to those of the illumination optical system of the first exemplary embodiment are given the same reference numbers as in the first exemplary embodiment, and redundant explanation is omitted.

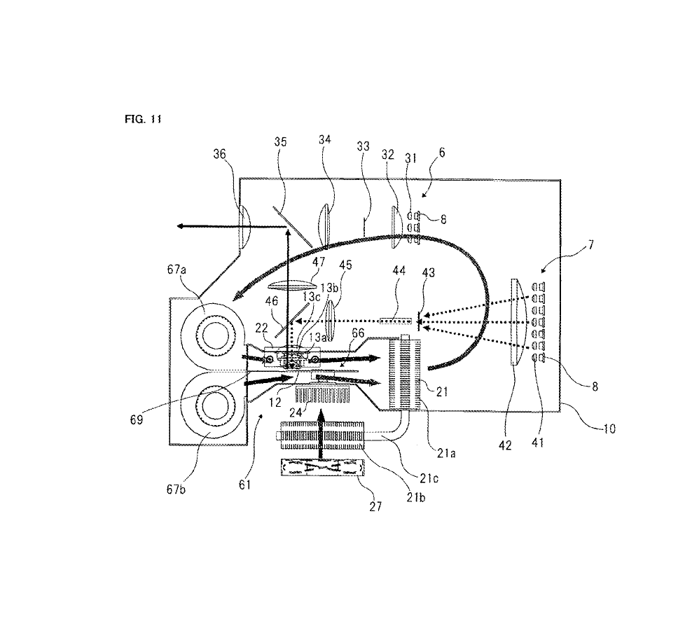

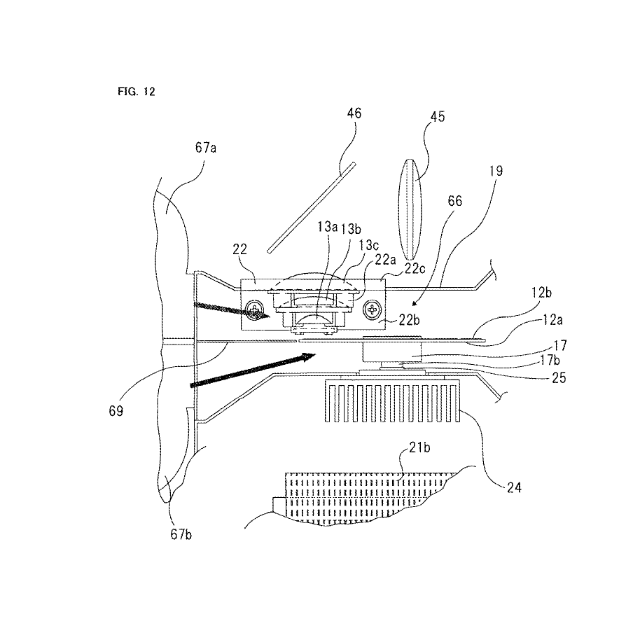

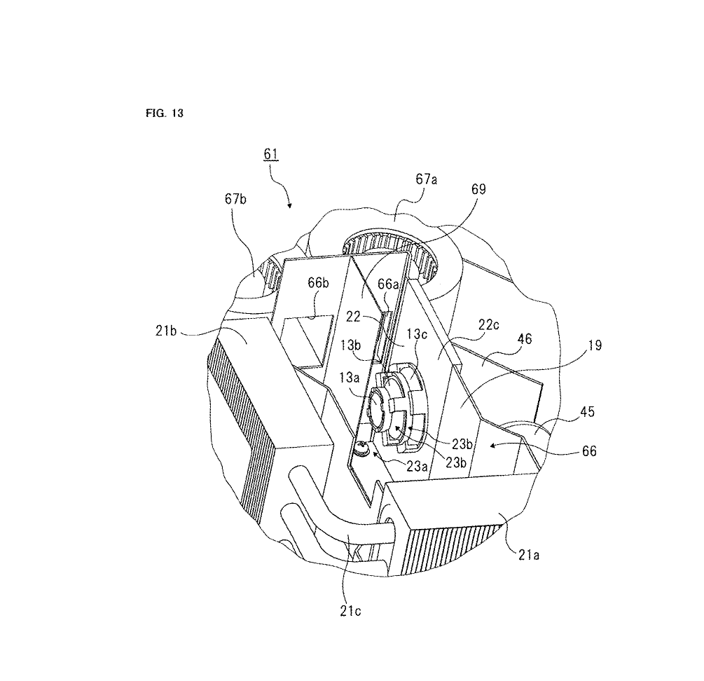

FIG. 10 shows a perspective view for describing the cooling structure of the illumination optical system of the second exemplary embodiment. FIG. 11 shows a plan view of the cooling structure of the illumination optical system of the second exemplary embodiment. FIG. 12 shows an enlarged plan view of the cooling structure of the illumination optical system of the second exemplary embodiment. FIG. 13 shows a perspective view of the duct and lens holder belonging to the cooling structure of the illumination optical system of the second exemplary embodiment.

As shown in FIGS. 10 and 11, cooling structure 61 of the illumination optical system of the second exemplary embodiment is provided with duct 66 that includes dividing wall 69 that divides the internal space, and first fan 67a and second fan 67b that supply cooling air to each space in duct 66 that is divided by dividing wall 69.

As shown in FIGS. 12 and 13, dividing wall 69 that divides the internal space of duct 66 into a first space that includes one surface of substrate 12a and a second space that includes the other surface of substrate 12b is provided between first and second fans 67a and 67b and fluorescent wheel 12 inside duct 66. Dividing wall 69 is provided to extend along partition wall 19 from one end of duct 66 to a position adjacent to fluorescent wheel 12. As shown in FIG. 13, port 66a that is linked to the air supply port of first fan 67a and port 66b that is linked to the air supply port of second fan 67b are formed at one end of duct 66.

In cooling structure 61 of the illumination optical system of the second exemplary embodiment as described hereinabove, the cooling air that is supplied from first fan 67a flows through one space of the internal space of duct 66 that is divided by dividing wall 69 and is guided to the surface of fluorescent wheel 12 on the side on which fluorescent layer 12b is formed. Similarly, cooling air that is supplied from second fan 67b flows through the other space of the internal space of duct 66 that is partitioned by dividing wall 69 and is guided to the other surface of fluorescent wheel 12. In this way, each cooling air flow is guided smoothly to the two sides of fluorescent wheel 12 in the present exemplary embodiment.

According to cooling structure 61 of the illumination optical system of the second exemplary embodiment, the provision of dividing wall 69 and first and second fans 67a and 67b enables the cooling air to be smoothly guided to both sides of fluorescent wheel 12 and can obtain a further increase of the cooling efficiency of the fluorescent material.

Further, although the cooling structure of the illumination optical system according to the present invention was used in an illumination optical system that is provided with a fluorescent wheel, the cooling structure may also be used in another illumination optical system as necessary. The present invention may also be used in an illumination optical system that uses a color wheel that has a color filter into which light from a light source is irradiated or in another illumination optical system that uses a fluorescent material of fixed construction.

Although the present invention has been described with reference to exemplary embodiments, the present invention is not limited to the above-described exemplary embodiments. The configuration and details of the present invention are open to various modifications within the scope of the present invention that will be clear to one of ordinary skill in the art.

### EXPLANATION OF REFERENCE NUMBERS

1 projection display apparatus
3 illumination optical system
7 second laser light source
11 cooling structure
12 fluorescent wheel
12a substrate
12b fluorescent layer
15 fan
16 duct
17a rotational axis

1. A cooling structure for an illumination optical system comprises:
a fluorescent unit having a fluorescent layer that emits fluorescent light in response to excitation light that is irradiated from a light source;
a fan that supplies cooling air to said fluorescent unit; and
a duct that partitions an internal space in which the fluorescent unit is arranged from an external space and that guides cooling air supplied from said fan to said fluorescent unit.

2. The cooling structure for an illumination optical system as set forth in claim 1, wherein:
said fluorescent unit is composed of a substrate on which said fluorescent layer is formed; and
said substrate is configured to be rotatable.

3. The cooling structure for an illumination optical system as set forth in claim 1, wherein:
a dividing wall that divides said internal space into a first space that contains one surface of said substrate and a second space that contains the other surface of said substrate is provided inside said duct between said fan and said fluorescent unit.

4. The cooling structure for an illumination optical system as set forth in claim 3, wherein:
said fan includes a first fan that supplies cooling air to said first space and a second fan that supplies cooling air to said second space.

5. The cooling structure for an illumination optical system as set forth in claim 1, further comprising:
a lens that is arranged inside said duct and that condenses fluorescent light that is emitted from said fluorescent layer; and
a lens holder that is arranged adjacent to said fluorescent unit and that supports said lens;
wherein:
a first air passage through which cooling air supplied from said fan passes is provided between said lens holder and said fluorescent unit.

6. The cooling structure for an illumination optical system as set forth in claim 5, wherein:
said lens holder has a support unit that supports the outer periphery of said lens; and
said support unit is provided with second air passages through which passes cooling air supplied from said fan.

7. The cooling structure for an illumination optical system as set forth in claim 1, wherein:
a cooling component that cools cooling air is provided in said duct on the downstream side of said fluorescent unit.

8. The cooling structure for an illumination optical system as set forth in claim 1, wherein a heat-discharging part is provided that is arranged outside said duct.

9. The cooling structure for an illumination optical system as set forth in claim 7, further comprising a heat-discharging part that is arranged outside said duct;
wherein:
said cooling component includes a heat-receiving part that is arranged inside said duct and a cooling unit that is linked to said heat-receiving part and that is arranged outside said duct; and
a fan for discharging heat is provided outside said duct and supplies cooling air to said heat-discharging part and said cooling unit.

10. A projection display apparatus comprising:
an illumination optical system that includes the cooling structure for an illumination optical system as set forth in claim 1; and
an image generation optical system that includes an image element that modulates light emitted from said illumination optical system with an image signal.
